(19) United States
(12) Patent Application Publication
(10) Pub. No.: US 2020/0269409 A1
(43) Pub. Date: Aug. 27, 2020

(54) POWER TOOL INCLUDING A LIGHT-DUTY COMBUSTION ENGINE

(71) Applicant: Walbro LLC, Tucson, AZ (US)

(72) Inventors: Matthew A. Braun, Caro, MI (US); Cyrus M. Healy, Ubly, MI (US); Robby L. Linton, Saginaw, MI (US)

(21) Appl. No.: 16/647,896

(22) PCT Filed: Sep. 28, 2018
(86) PCT No.: PCT/US2018/053365

§ 371 Date: Mar. 17, 2020

Related U.S. Application Data
(60) Provisional application No. 62/564,839, filed on Sep. 28, 2017.

(51) Int. Cl. B25F 5/02; F02B 63/02

(52) U.S. Cl. CPC B25F 5/02; B27B 17/10; F02B 63/02

(57) ABSTRACT

A power tool may include an engine, a tool driven for movement by the engine, a brake mechanism coupled to the tool, a charge forming device coupled to the engine and a transmission member operably coupled to the brake mechanism and a throttle valve of the charge forming device. The brake mechanism inhibits movement of the tool in an engaged position of the brake mechanism and permits movement of the tool in a disengaged position of the brake mechanism. The charge forming device is coupled to the engine to provide a combustible fuel and air mixture to the engine, and the throttle valve is movable between a first position and a second position. The transmission member is operably coupled to the brake mechanism and the throttle valve so that the throttle valve is moved away from the first position when the brake mechanism is moved to the engaged position.

### REFERENCE TO RELATED APPLICATIONS

This application claims the benefit of U.S. Provisional Application Ser. No. 62/564,839 filed on Sep. 28, 2017 the entire contents of which are incorporated herein by reference in its entirety.

### TECHNICAL FIELD

The present disclosure relates generally to power tools that include a light-duty combustion engine, and to controlling an engine and a power tool having a brake mechanism.

### BACKGROUND

Power tools may include a tool, such as a chain or blade, that is driven by an engine. The tool may have one or both of a brake and a clutch to control actuation or driving of the tool. Starting the tool may require a multi-step process of engaging the brake and/or clutch, adjusting one or more valves of a charge forming device, such as a choke valve or throttle valve, and actuating a priming pump or the like to purge the charge forming device of stale fluids. Such complicated starting processes are not desirable for end users who may omit one or more steps which may impact the ability of the engine to easily start and/or user safety during starting of the engine.

### SUMMARY

A power tool may include an engine, a tool driven for movement by the engine, a brake mechanism coupled to the tool, a charge forming device coupled to the engine and a transmission member operably coupled to the brake mechanism and a throttle valve of the charge forming device. The brake mechanism inhibits movement of the tool in an engaged position of the brake mechanism and permits movement of the tool in a disengaged position of the brake mechanism. The charge forming device is coupled to the engine to provide a combustible fuel and air mixture to the engine, and the throttle valve is movable between a first position and a second position. The transmission member is operably coupled to the brake mechanism and the throttle valve so that the throttle valve is moved away from the first position when the brake mechanism is moved to the engaged position.

In at least some implementations, the transmission member includes one or more of a rigid member and a cable. The brake mechanism may include a band having a fixed end and a movable end, and the transmission member may be operably coupled to the movable end of the band. Moving the brake mechanism to the disengaged position may move the throttle valve to the first position. In at least some implementations, the power tool includes a clutch through which the engine drives the tool, and the brake mechanism is coupled to the clutch in the engaged position.

In at least some implementations, the charge forming device includes a choke valve and wherein the transmission member is coupled to the choke valve to move the choke valve from an open position to a closed position when the brake mechanism is moved to the engaged position. The choke valve may be operably coupled to the throttle valve so that upon movement of the choke valve to the closed position the throttle valve is moved to a position between the first position and second position.

The power tool may include a switch having a first state and a second state. The switch may be operable to provide an output indicative of the state of the switch to a controller, and the switch may be operably coupled to the brake mechanism so that the switch is in the first state when the brake mechanism is in the engaged position and the switch is in the second state when the brake mechanism is in the disengaged position.

In at least some implementations, a component of the brake mechanism or a component moved by the brake mechanism engages the switch to change the state of the switch when the brake mechanism is moved to either the engaged or disengaged position. The switch may be coupled to a microprocessor and to an electrical ground, where the electrical ground includes a portion of the brake mechanism or a portion of a clutch through which the engine drives the tool. The switch may be defined by a magnet and a sensor responsive to relative movement between the magnet and sensor.

In at least some implementations, a power tool includes an engine, a tool driven for movement by the engine, a brake mechanism coupled to the tool to inhibit movement of the tool in an engaged position of the brake mechanism and permit movement of the tool in a disengaged position of the brake mechanism, and a switch. The switch has a first state and a second state, and the switch is operably coupled to the brake mechanism so that the switch is in the first state when the brake mechanism is in the engaged position and the switch is in the second state when the brake mechanism is in the disengaged position.

In at least some implementations, the brake mechanism includes a lever movable between a first position in which the brake mechanism is in the engaged position and a second position in which the brake mechanism is in the disengaged position, and the state of the switch changes when the lever moves between the first and second positions. A controller may include a processing device, and the switch may be coupled to the controller so that the controller is responsive to a change of state of the switch. A component of the brake mechanism or a component moved by the brake mechanism may engage the switch to change the state of the switch when the brake mechanism is moved to either the engaged or disengaged position. The switch may be defined by a magnet and a sensor responsive to relative movement between the magnet and sensor.

In at least some implementations, a method of controlling operation of a tool having an engine and a brake mechanism, includes coupling the brake mechanism to one or both of a switch and a valve of a charge forming device so that: 1) actuating the brake mechanism changes the state of the switch and initiates an engine starting control routine and/or the position of the valve is changed; and 2) releasing the brake mechanism changes the position of the mechanical component to a desired position associated with operating the tool and/or changes the state of the switch to i) terminate the engine starting control routine, or ii) initiate a tool operating engine control routine.

In at least some implementations, the method also includes configuring the tool so that the brake mechanism must be actuated in order to permit starting of the engine. The valve may be a throttle valve and actuating the brake mechanism thereby moves the throttle valve from an idle position to a position between the idle position and a wide open position. In at least some implementations, the brake mechanism is connected to a choke valve to move the choke valve when the brake mechanism is engaged, and wherein the movement of the choke valve causes movement of the throttle valve.

In at least some implementations, the tool is configured to terminate engine operation upon actuation of the brake mechanism after the engine has been started by sending a signal to an engine controller when the state of the switch is changed by such actuation of the brake mechanism. In at least some implementations, the engine controller is configured to terminate at least some ignition events in the engine to cause the engine operation to terminate.

In at least some implementations, a power tool includes an engine, a tool driven by the engine, a controller associated with the engine and capable to cause termination of engine operation, and a switch communicated with the controller, wherein the switch includes a magnet and a sensor responsive to movement of the magnet and, upon actuation of the switch, the magnet is moved relative to the sensor and the sensor provides a signal to the controller to cause the controller to terminate engine operation.

In at least some implementations, the magnet is carried by a movable part of the switch for movement relative to the sensor. The magnet may be coupled to a component connectable to a user of the power tool so that the magnet may be moved by the user, and the component that is connectable to a user may include one or more of a tether, a glove or a strap. The power tool may also include a throttle control that is manually actuatable by a user to control a throttle valve of the engine, and the sensor may be located in the area of the throttle control and the magnet is adapted to be carried or coupled to a hand of the user that is used to actuate the throttle control.

In at least some implementations, a power tool includes an engine, a tool driven by the engine, a controller associated with the engine to control at least one aspect of engine operation, a sensor communicated with the controller and responsive to movement of a magnetic field relative to the sensor, and a magnet carried by the tool for movement relative to the sensor. The sensor provides a signal to the controller when the magnet is moved passed the sensor as the tool is driven by the engine. In at least some implementations, the magnet is defined by a magnetized portion of the tool.

Various combinations of these features may be combined in various embodiments of the tools and methods disclosed herein, to the point the features are not mutually exclusive. That is, the disclosure is not intended to be limited by the particular embodiments described in detail herein but is intended to permit combination of features among the embodiments as would be contemplated by persons skilled in this art upon reading this disclosure. For example without limitation, a power tool may include one or more of a switch/sensor that terminates engine operation when actuated, a switch/sensor that is carried by the tool driven by an engine and a switch that is coupled to a brake mechanism as set forth herein, and/or a brake mechanism that is coupled to a valve to move the valve in accordance with movement of the brake mechanism or a part thereof. The operations of the various switches or sensors or valves may be different and not mutually exclusive such that various embodiments may include all or fewer than all of the disclosed switches or sensors. Further, corresponding methods may be implemented that utilize the features of such combinations of switches and sensors and valves, as desired.

### BRIEF DESCRIPTION OF THE DRAWINGS

These and other objects, features and advantages will be apparent from the following detailed description of the preferred embodiments, appended claims and accompanying drawings in which:

FIG. 1 shows a chainsaw;

FIG. 2 is an exploded view of a portion of a clutch and brake mechanism for a chainsaw;

FIG. 3 is a perspective view of a portion of an actuating linkage for the brake mechanism;

FIG. 4 is a side view of a charge forming device;

FIG. 5 is a partial side view of a charge forming device;

FIG. 6 is a diagrammatic view of a detection element;

FIG. 7 is a flowchart of a method of operating a chainsaw;

FIG. 8 is a diagrammatic view of a flywheel, controller, and kill switch sensor arrangement for a power tool or other engine application;

FIG. 9 is a diagrammatic view of a handle of a power tool including a throttle trigger, and various non-contact sensor arrangements; and

FIG. 10 is a diagrammatic view of a saw chain that includes one or more magnets that may be sensed by a sensor adjacent the saw chain.

### DETAILED DESCRIPTION

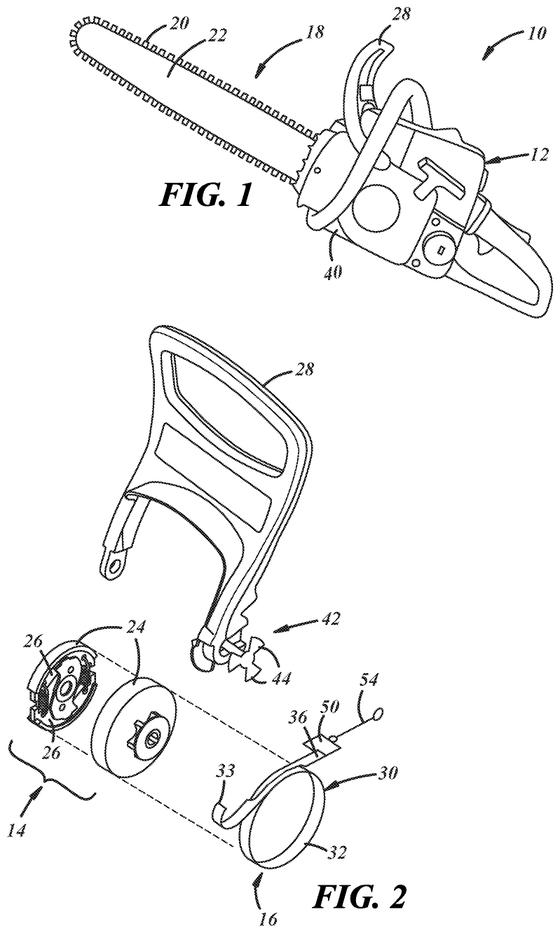

Referring in more detail to the drawings, FIGS. 1 and 2, illustrate a device 10 that includes a light-duty combustion engine 12, a centrifugal clutch 14, a brake mechanism 16 and a tool 18 driven by the engine through the clutch so that the tool is not driven when the engine is operating at lower speeds. While a chainsaw 10 is shown, the disclosure and teachings herein are not limited to chainsaws and may be implemented on other tools or devices having a tool driven through a clutch and/or including a brake mechanism to control operation of the tool, such as a weed trimmer or other lawn and garden equipment. The term ‘light-duty combustion engine’ broadly includes all types of non-automotive combustion engines—this includes engines that are two-strokes, four-strokes, carbureted, fuel-injected, and direct-injected, to name but a few. Light-duty combustion engines may be used with hand-held power tools, lawn and garden equipment, lawnmowers, grass trimmers, edgers, chainsaws, snowblowers, personal watercraft, boats, snowmobiles, motorcycles, all-terrain-vehicles, etc.

The chainsaw 10 includes a chain 20 that is rotated about a bar 22 to run cutting teeth of the chain into a tree limb or other object being cut by the chainsaw. The chain 20 is rotated by a drive sprocket that is driven by the engine 12, typically with the clutch 14 between the drive sprocket and engine. The clutch 14 is often a centrifugal clutch that includes a clutch drum 24 having an inner surface that is selectively frictionally engaged by multiple weighted clutch elements 26 that rotate with the engine 12. The clutch elements 26 are yieldably biased inwardly, away from the clutch drum inner surface, so that when the engine 12 and clutch elements rotate at lower speeds, the centripetal force acting on the clutch elements does not engage (or sufficiently engage) the clutch elements with the clutch drum 24 so that the clutch drum, drive sprocket and chain 20 are not driven (i.e. rotated). At a sufficiently high engine speed, the clutch elements 26 move outwardly into engagement with the clutch drum 24 and the clutch drum is driven with the clutch elements and engine 12, and the drive sprocket and chain 20 are driven for rotation with the clutch drum.

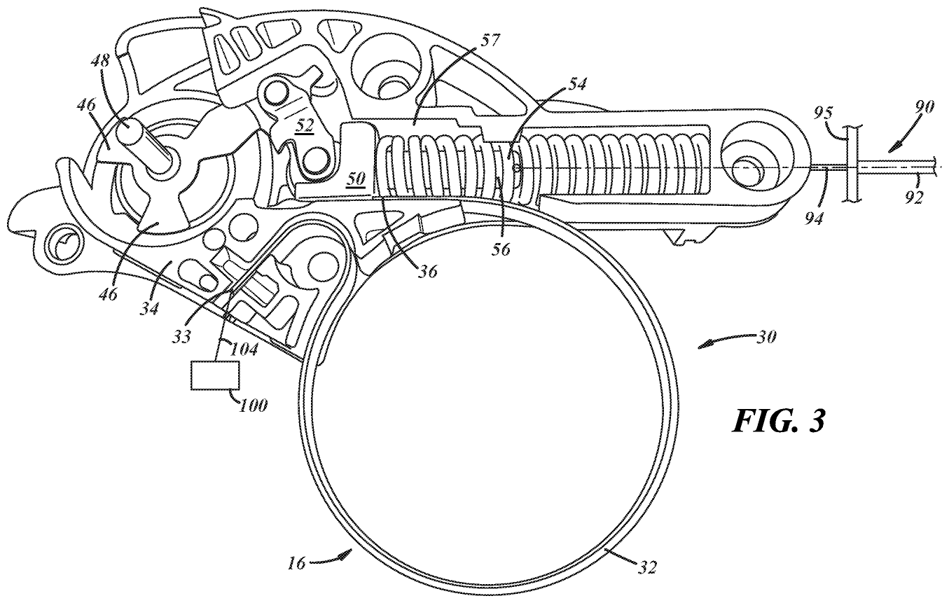

To slow or stop rotation of the clutch drum 24 when desired, the chainsaw may also include the brake mechanism 16. As shown in FIGS. 2 and 3, the brake mechanism 16 may include a lever 28 that actuates a brake element 30. In at least some implementations, the brake element includes a metal band 30 that has an annular or partially annular or curved portion 32 arranged adjacent to an outer surface of the clutch drum 24 for selective engagement with the clutch drum. One end 33 of the band 30 may be fixed, if desired, such as to a housing 34, and the other end 36 may be moved in a first direction to selectively reduce the inner diameter or size of the curved portion 32 of the band 30 and thereby engage the band with the outer surface of the clutch drum 24. This slows or stops the clutch drum 24 rotation and likewise the rotation of the chain 20. The movable end 36 of the band 30 may be moved in a second direction to increase the size of the curved portion 32 to reduce or remove the force on the clutch drum 24 and permit rotation of the clutch drum.

The movable end 36 of the band 30 may be coupled to a brake actuator, shown as a lever 28 that is accessible to and by an operator of the chainsaw 10, such as by extending outwardly from an exterior of a housing 40 of the chainsaw that covers the engine 12 and related components. Hence, when the lever 28 is moved from a first position (corresponding to the brake being disengaged) to a second position (corresponding to the brake being engaged), the movable end 36 of the brake band 30 is moved in the first direction and the band is engaged with the clutch drum 24 to inhibit or prevent rotation of the clutch drum. And when the brake lever 28 is moved from the second position back to the first position, the movable end 36 of the brake band 30 is moved in the second direction and the band is disengaged from the clutch drum 24. The brake band 30 may be located within the housing 40 and controlled by actuation of the lever 28 which is accessible from outside of the housing.

In the implementation shown, the lever 28 is coupled to a driven member 42 having spaced apart dogs 44. As shown in FIG. 3, mating or complementary driven dogs 46 are fixed to a shaft 48 about which the lever 28 pivots and interleaved with the drive member dogs 44 so that when the brake lever is moved (e.g. pivoted about the shaft 48), the shaft is rotated. The shaft 48, in turn, is coupled to the brake band 30, such as by a slider 50 which is coupled to the dogs 46 and shaft 48 by one or more links 52. The slider 50 may be acted upon by a spring 54 (e.g. a coil spring received over a pin 56 extending from the slider) that yieldably biases the brake mechanism 16 to or toward its engaged position. In this way, the brake lever 28 must be moved against the force of the spring 54 to release the brake mechanism 16. In the disengaged position, the spring 54 may be compressed and may act on the shaft 48 through the link 52 that is rotated to a position wherein the spring force does not displace the brake lever 28 (like an over-center toggle, where the force on the link tends to act through the shaft and does not rotate the shaft and brake lever). Upon rotation of the brake lever 28 a portion of the distance toward the engaged position, the link 52 is arranged so that the spring 54 tends to rotate the shaft 48 and hence, the brake lever 16, and the spring assists further movement of the brake lever to the engaged position and resists movement of the brake lever away from the disengaged position. This helps to ensure that the brake lever 28 remains engaged when intended and the brake lever is not unintentionally or inadvertently moved away from the engaged position. As the brake lever 28 is pivoted, the dogs 46 rotate about pin or shaft 48 and the slider 50 moves within a slot or track 57 in the housing 34 to move the movable end 36 of the band 30.

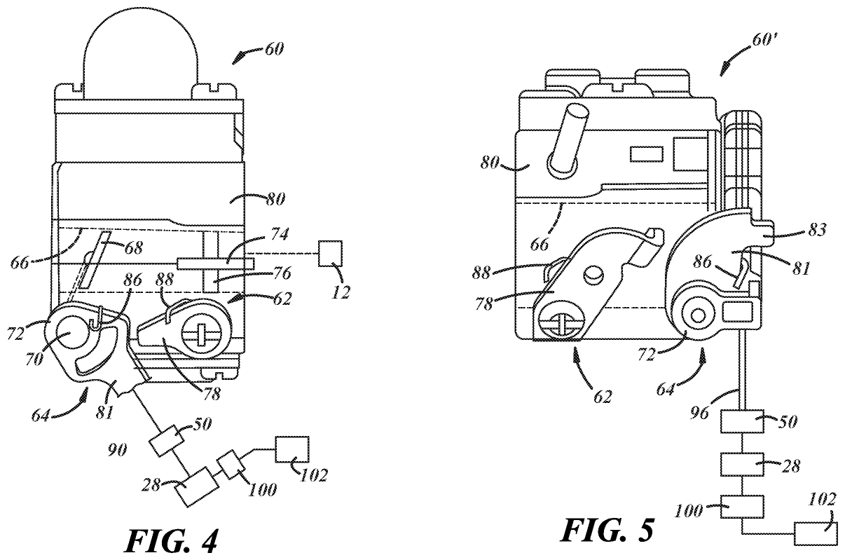

To power the engine 12, a charge forming device 60 (FIG. 4) may be coupled to the engine to supply a combustible fuel and air mixture to the engine. As set forth below, in at least some implementations, the brake mechanism 16 may be coupled to the charge forming device 60 to control one or more settings of the charge forming device at least when the brake is engaged. Conveniently, the brake 16 may be engaged as part of a starting procedure for the engine 12, as set forth in the flow chart of FIG. 7, so that actuation of the brake may also be used to control the charge forming device 60 and/or provide an indication that the engine is going to be started to an ignition control system to enable ignition control consistent with initial engine starting and initial engine warm-up.

FIGS. 4 and 5 illustrate two versions of a charge forming device 60, 60′ from which a fuel and air mixture is delivered to the engine 12. The features relevant to the below discussion may be common among the devices 60, 60′ so only the device 60 will be described unless specific reference is made to FIG. 5. For ease of description and understanding, components in the device 60′ that are the same as or similar to components in the device 60 will be given the same reference numerals in FIG. 5 as in FIG. 4, and vice versa.

The charge forming device has a throttle valve 62 and may also have a choke valve 64 (parts of both are diagrammatically illustrated in FIG. 4) both of which control at least part of the fluid flow through a main bore 66 to control the flow rate of a fuel and air mixture to the engine 12. The choke valve 64 may be a butterfly type valve having a valve head 68 within or adjacent to the main bore 66, a rotatable shaft 70 to which the valve head is connected and a choke valve lever 72 coupled to the shaft to facilitate rotating the choke valve shaft in known manner. Levers 72 may be provided on or adjacent to one or both ends of the shaft 70. The throttle valve 62 may also be a butterfly valve, by way of a non-limiting example, having a throttle valve head 74 within or adjacent to the main bore 66 and spaced from the choke valve head 68, a rotatable throttle valve shaft 76 to which the throttle valve head is connected and a throttle valve lever 78 coupled to the throttle valve shaft to facilitate rotating the throttle valve shaft. In known manner, the throttle valve 62 (e.g. via the lever 78) may be linked to a throttle valve actuator (e.g. a manually operable trigger or switch) by a suitable cable (e.g. a Bowden cable) that may be coupled to an operator actuatable trigger or other throttle control member.

To vary the air flow through the main bore 66, the throttle valve 62 may be actuated and movable between a first or idle position and a second or wide-open throttle (WOT) position in response to actuation of the trigger (for example). In general, the flow area, which is defined between the throttle valve 62 and a body 80 of the charge forming device 60 that defines the main bore 66, may be at a maximum when the throttle valve is in the wide-open position and the flow area may be at a minimum when the throttle valve is in the idle position. The throttle valve lever 78 may include or be engaged by one or more other levers or components to control actuation of the choke valve 64 (if provided), and/or to temporarily hold the throttle valve 62 in a position between the idle and wide-open positions. In one example, the throttle valve 62 may be held in a position off-idle (that is, between the idle and wide open positions, usually closer to idle than wide open) to cause the engine to run at a fast-idle speed. As noted above, the fast-idle engine operation may be useful to facilitate warming up a cold engine and maintaining initial engine operation (e.g. avoiding a stall). As shown in FIG. 5, a fast-idle lever 81 may be associated with the choke valve 64 to selectively engage the throttle valve 62 and move the throttle valve off its idle position to an intermediate or start position. In summary, rotation of the choke valve 64 to its closed position may cause the fast-idle lever 81 to engage the throttle valve lever 78 and rotate the throttle valve to the intermediate position. Rotation of the choke valve back to its open position will disengage the fast-idle lever 81 from the throttle valve lever 78 and permit the throttle valve to move to its idle position without interference from the fast-idle lever. Rotation of the throttle valve toward its wide open position may also disengage the throttle valve lever 78 from the fast-idle lever 81, and the choke valve may automatically (e.g. under force of a spring) rotate back to its open position, thereby removing the fast-idle lever from the path of movement of the throttle valve lever 78. Lever arrangements to hold a throttle valve in an intermediate or third position between the idle and wide open positions are taught in U.S. Pat. Nos. 6,439,547 and 7,427,057, the disclosures of which are incorporated herein by reference in their entirety.

In at least some implementations, a starting procedure for an engine may include moving the throttle valve 62 to an intermediate position associated with fast-idle or other off-idle engine operation, and purging and/or priming the charge forming device 60 in known manner. The throttle valve 62 may be moved to the desired position by moving a handle or lever coupled to the throttle valve lever 78, the choke valve lever 72 (which in turn engages the throttle valve lever to rotate the throttle valve) or by directly manipulating the throttle valve lever. In some systems, a solenoid or other powered actuator may be used to move the throttle valve, if desired.

As shown in FIG. 5, a lever, which in at least some implementations is the brake lever 28 that is coupled to the brake band, is moved from the first, unactuated position to the second, actuated position to engage the brake with the clutch drum. This movement of the brake lever 28 moves the choke valve from its open position to its closed position. During this movement of the choke valve, the fast-idle lever 81 engages the throttle valve lever 78 and moves the throttle valve 62 from its idle position to the intermediate or fast-idle position. A first biasing member 86 may be coupled to or provide a force on the choke valve to provide a force tending to return the choke valve to its unactuated or open position. A second biasing member 88 may act on the throttle valve 62 tending to rotate the throttle valve to its idle position. The biasing force on the throttle valve 62 may be used to maintain the throttle valve lever 78 engaged with a stop surface 83 on the fast-idle lever 81 that is moved into the path of movement of the throttle valve lever when the brake lever 28 is actuated. Subsequent actuation of the throttle valve 62 by a user, e.g. by actuating a trigger, moves the throttle valve lever 78 away from the fast-idle lever 81 so that the throttle valve may move between the idle and wide open positions without interference from the fast-idle lever, and the choke valve 64 may move to its open position under the force of its return spring 86. In this way, the fast-idle engine operation can be terminated automatically upon actuation of the throttle valve 62.

As shown in FIG. 3, the brake mechanism 16 may be coupled to the throttle valve 62 via a cable 90, such as a Bowden cable so that actuation of the brake mechanism causes a desired movement of the throttle valve and/or choke valve 64. The cable 90 may include an outer conduit 92 and an inner cable 94 received within the conduit and slidably movable relative to the conduit. The inner cable 94 may be coupled at one end to the fast-idle lever 81, the choke valve 64 (e.g. the lever 72 on the choke valve shaft 70) or to a lever on the throttle valve shaft 76, and the other end of the inner cable 94 may be coupled to the slider 50 (or other portion of the brake mechanism 16 that provides desired movement for actuation of the throttle valve via the cable). The conduit ends may be fixed to a nonmoving structure(s) (e.g. a bracket 95 as shown in FIG. 3) to permit movement of the inner cable 94 relative to the conduit 92 to actuate the throttle valve 62 and/or choke valve 64.

As shown in FIG. 5, a rod 96 or other rigid member may couple the brake mechanism with the throttle valve 62 and/or choke valve 64. As with the inner cable 92, at one end the rod 96 may be coupled to the slider 50 or other moving portion of the brake mechanism 16 and at its other end the rod may be coupled to or engageable with one of the valves 62, 64. For example, a lever 72, 78, 81 on one of the valves 62, 64 may be within the path of movement of the rod 96 that is caused by movement of the brake mechanism 16 between its engaged and disengaged positions. In this way, the rod 96 may engage and move a lever of one or both valves to move the valves to a desired position. The rod 96 may be fixed to a lever 72, 78, 81 or may simply engage and displace a lever during a portion of the movement of the rod.

Regardless of the form, in at least some implementations there is a transmission member that is responsive to movement of part of the brake mechanism 16 and which causes movement in one or both of the throttle valve 62 and choke valve 64. In at least some implementations, the transmission member moves or causes movement of the throttle valve 62 to a position desired to support starting of the engine 12, such as a fast-idle position that is between the idle and wide-open (WOT) positions of the throttle valve. Movement of the brake mechanism 16 toward its disengaged position may move or release the throttle valve 62 back to its idle position or to another position commanded by the operator (e.g. via a throttle trigger). The throttle valve 62 may also be moved or released so that it can move from the fast-idle position by actuation of the throttle valve by the operator instead of by movement of the brake lever 28.

In at least some implementations, the operating speed of the engine 12 is limited, at least upon starting the engine, and perhaps also during initial warming up of the engine. In some implementations, the speed may be limited to a speed below a clutch-in speed of a tool 18 associated with the engine 12, for example, the chain 20 of the chainsaw 10. This prevents the chain 20 from being actuated during staring and initial warming up of the engine, and until the throttle valve 62 is actuated by a user to begin operation of the chain. When the throttle valve 62 is actuated, the user's hands are usually in proper position on the chainsaw 10. However, in some implementations, such as set forth herein, the engine speed is limited not only by throttle valve position but also by control of the ignition timing and/or number of ignition events that occur (e.g. some ignition events are skipped to control engine speed). Accordingly, actuation of the throttle valve 62 by the user may not result in the engine speed increasing, at least to the extent desired by the user, if these other controls are still active.

In at least some implementations, a detection element or switch 100 is operably coupled to (i.e. associated with) the brake lever 28 and/or a component actuated or moved when the brake lever is moved, for example but not limited to, the slider or spring or link or drive member. For example, a switch 100 may be in a first state when the brake lever (or other component) is in a first position and the switch may be in a second state when the brake lever (or other component) is in a second position. The brake lever 28, or other component that moves when the brake lever is moved, may directly engage the switch 100 and change the state of the switch, as desired.

In at least some implementations, the first state of the switch 100 is open and the second state is closed. Further, the first position of the brake lever 28 (or other component) may be the actuated or engaged position and the second position of the brake lever 28 (or other component) may be the released or disengaged position of the brake mechanism. Accordingly, the switch 100 may be open unless the brake lever 28 or other component is in its engaged position. Of course, the switch 100 can be otherwise arranged (e.g. the first state may be closed and the second state may be open), a sensor may be used instead of a switch to detect brake lever movement (e.g. magnetically sensitive sensor wherein a magnet is moved relative to a sensor when the position of the brake mechanism is changed, an optical sensor or other sensor types responsive to brake mechanism movement may also be used).

Thus, the switch 100 can be used to determine if the brake lever 28 is in its position that causes the brake mechanism to be engaged or not. At least in implementations wherein the engine speed is controlled to below a desired threshold (e.g. below clutch-in speed) such as by skipping ignition events or changing ignition timing, the switch may be used to determine when the brake lever has been moved to disengage the brake mechanism. Detection of the brake mechanism 16 being disengaged can be used, for example, to terminate the engine speed control actions and thereafter permit operator control of the throttle valve between the idle and WOT positions.

As shown in FIGS. 4-6, the switch or sensor may be operably coupled to or otherwise associated with a microprocessor, controller or other processing device 102 which may control one or more of the processes noted above, including engine speed control and/or control of the ignition system to enable termination of engine speed reduction or control as noted herein, as a function of the state of the switch 100. The switch 100 may be operable to provide an output indicative of the state of the switch to the controller 102, or the controller may otherwise be responsive to a change in state of the switch. The switch 100 may be coupled to the clutch drum 24 or other component that is itself grounded, to connect the switch to ground. In at least some implementations, as shown in FIG. 3, the switch 100 may include a terminal or wire 104 that is coupled to the brake band 30. When the brake band 30 is sufficiently engaged with the clutch drum 24 (e.g. so that the brake band and clutch drum are electrically coupled), a circuit including the switch 100 is complete and this defines a first state of the switch. When the brake band 30 is not sufficiently engaged with the clutch drum 24, the switch 100 circuit is open or not complete and this defines a second state of the switch. Of course, the switch 100 could be otherwise arranged.

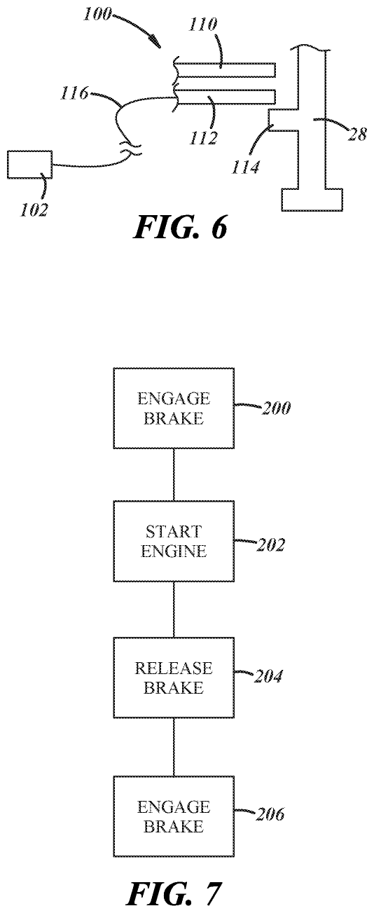

The switch 100 may be a toggle switch that is moved between two positions by movement of the brake lever or other component. The switch 100 may also be inexpensively and simply implemented as two conductors 110, 112 (FIG. 6) which may be simple pieces of metal (e.g. spring steel) that have a portion (e.g. free ends) adjacent to each other and either moved together (e.g. by a tab 114 on brake lever 28) to complete a circuit path (e.g. close the switch) or moved apart or permitted to move apart to open a circuit path (e.g. open the switch). The conductors 110, 112 may be electrically communicated with the microprocessor or other controller or circuit, as desired. In at least one form, a wire 116 may be connected to one conductor 112 and to the microprocessor 102 or some part of the circuit that is coupled to the microprocessor. The conductors 110, 112 may be flexible so that they flex when engaged by the brake lever 28 or other component to engage each other, and the conductors may be resilient to return toward their unflexed or unbent positions and thereby disengage from each other when not forced against each other, which is a normally open arrangement. The conductors 110, 112 may also be arranged in a normally closed position and then separated by or in response to movement of the brake lever 28 or other component, if desired. Movement of at least one component in response to disengagement of the brake lever is thus detected by a switch, sensor or other detection element 100 to enable deactivation of an engine speed control process or system.

A method for starting an engine is set forth in FIG. 7. The method may begin at step 200 wherein the brake mechanism is engaged. When the brake mechanism 16 is engaged, the throttle valve 62 may be in a desired position for starting the engine 12 (e.g. fast-idle) and the choke valve 64 (if provided) may be closed. The switch 100 is also in a first state which may be detected by a controller 102. The controller 102 may then cause one or more things to happen to facilitate starting the engine 12, and to control initial engine warm-up, such as by initiating an engine starting routine which may include various instructions or steps executed or controlled by the controller. For example, the controller 102 may cause an ignition timing to be set to facilitate starting, and/or may enable a speed control mode designed to maintain the engine speed below a certain threshold (e.g. clutch-in speed). Optionally, the controller 102 does not permit the engine 12 to be started unless the brake mechanism 16 is engaged (e.g. as determined by the state of the switch 100). This may be accomplished, for example, by preventing ignition events from occurring during attempted engine starts. With the system set for starting, the engine 12 may be started in the usual manner (e.g. by electric or manually starting mechanism), which is step 202.

After the engine 12 is started, and prior to using the chainsaw 10, the brake mechanism 16 needs to be released, step 204, so that the chain 20 is free from the brake mechanism and may be driven by the engine through the clutch 14 in normal manner. Releasing the brake mechanism 16 may do one or more things. For example, the throttle valve 62 may be released from the fast-idle or starting position and be permitted to move to the idle position (assuming the operator is not actuating the throttle trigger), or this may occur in response to and after initial throttle actuation by the operator. Release of the brake mechanism 16 may also change the state of the switch 100 and this may cause the controller 102 to terminate the engine speed control associated with starting the engine and/or change the ignition timing to facilitate subsequent use of the chainsaw 10. The controller 102 may implement a tool operating engine control routine which may monitor or control engine operation associated with normal use of the tool. This may include, among other things, setting engine speed control limits or other programs/subroutines associated with normal use of the chainsaw 10, such as ignition timing and fuel/air mixture control schemes to facilitate engine acceleration and deceleration, and speed control associated with a maximum engine speed and the like.

After use of the saw 10 and to terminate engine operation, at step 206 the brake 16 may be moved back to its engaged position. Doing so changes the state of the switch 100, which is detected by the controller 102. The controller 102 may then, for example, terminate ignition events to cause the engine to cease operation. In this way, the switch 100 may act as a kill switch and no separate kill switch is necessary on the chainsaw 10. However, if desired, a separate kill switch may be provided. Among other things, this may enable the brake mechanism 16 to be engaged without terminating engine operation so that the brake may engaged between cuts with the chainsaw 10 or for other reasons, without killing the engine 12. Conveniently, when the brake mechanism is engaged to cease engine operation, the brake mechanism 16 (and optionally the throttle and/or choke valves 62, 64) is in position for a subsequent engine start, which process may then start at step 202. That is, the system may reset after the brake mechanism is actuated or engaged to terminate engine operation and after engine operation has terminated, to then be ready to provide a desired engine starting control routine or other engine operating control routine when the engine is started again.

In at least some implementations, the brake mechanism 16 needs to be actuated before the engine 12 may be started, and this may conveniently be determined by the state of a switch 100 that is responsive to actuation (engagement and/or disengagement) of the brake mechanism. Thus, there is less chance that the chain 20 will be driven during the starting and initial warming-up of the engine 12. Engaging the brake may also move a mechanical component, such as the throttle valve, to a desired position for starting the engine (e.g. to the fast-idle position). Further, the system may automatically initiate an engine starting mode in which a desired ignition timing and fuel/air mixture may be supplied to the engine, and the engine speed may be controlled as desired. This may, among other things, maintain the engine speed below a clutch engagement speed. With the brake 16 engaged, allowing the engine speed to reach or exceed the clutch engagement speed would force the brake mechanism 16 to hold the clutch drum 24 stationary which could stress the clutch friction elements 26 (and associated drive shaft and other components), clutch drum 24 and the brake band 30. By limiting the engine speed when the brake is engaged, the system reduces wear on the clutch and brake.

Further, to use the saw 10, the brake mechanism 16 must be disengaged which can be detected, for example, by a change of state of the switch 100. This may cause the engine control mode to change to a normal operating mode (e.g. associated with operation of the tool) from the starting mode, and thereby permit the engine 12 to exceed the clutch engagement speed so that the chain 20 may be driven as commanded by the chainsaw operator. This change in operating mode may occur automatically as the brake mechanism 16 is released, for example by detecting or determining a change in the state of the switch. The change in state of the switch is easy to reliably detect or determine and need not be confirmed, for example, by detecting or determining a change in throttle valve 62 position or the like (i.e. operator commanded throttle change indicative of operator desire to use the saw in a normal operating mode) which may be difficult to detect when an engine speed control process is occurring. The switch 100 may be used for multiple purposes, including as a kill switch to cease engine operation, and the switch may be easily implemented for reliable actuation, and may be inexpensively implemented with a single wire (e.g. coupled to the brake band which selectively completes a circle when engaged with the clutch drum). Hence, minor changes are needed to an existing saw 10 and brake mechanism 16 to implement the features and advantages set forth herein. For example, all that may need to be added is a switch 100 responsive to brake mechanism 16 movement and optionally a mechanism to change the position of the throttle valve 62 when the brake is engaged (if a fast-idle or other throttle position is desired at engine start-up).

The switch 100 used may be of various different constructions and arrangements. The switch could be physically moved between the first and second states by a mechanical coupling or mechanical force applied to the switch as the brake mechanism is engaged and disengaged. The switch could also be a contactless switch that changes states as the function of movement of a component relative to the switch, such as via a magnetic field movement or change caused by the movement. For example, a hall-effect sensor may be used to determine movement of the brake mechanism, for example by being located near a moving component of the brake mechanism (e.g. the lever 28, band 30, slider 50, dogs 46, link 52, spring 54, pin 56, cable 90, etc) or a component that is moved by a component of the brake mechanism (e.g. the choke or throttle valve or fast-idle lever). The sensor may include a magnet and a magnetically responsive sensor, one of which is moved relative to the other when the brake mechanism is moved from one position (e.g. engaged) to the other position (e.g. disengaged). Typically, the sensor is fixed in place and the magnet is moved, such as by being carried by or by being a magnetized component (e.g. a pin) of a movable part of the assembly. The sensor may be coupled to the controller to provide a signal to the controller indicative of the state of the switch or changing state of the switch.

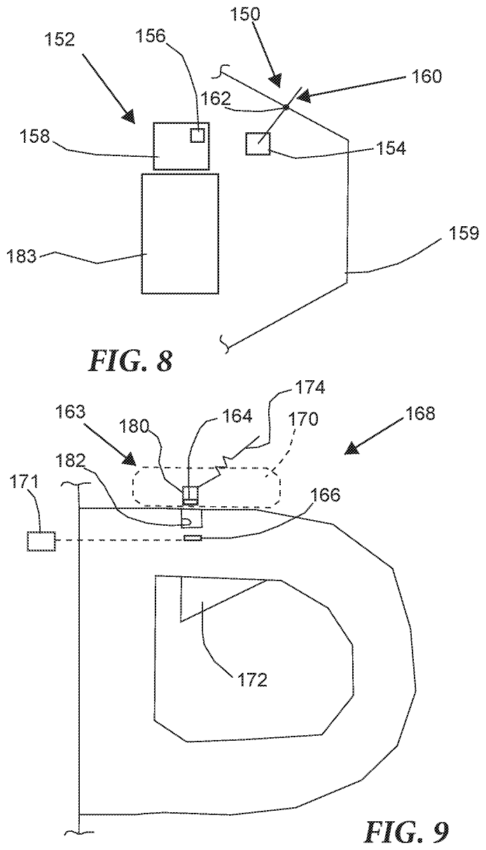

Such a switch could also be used for other purposes on a tool. For example, as shown in FIG. 8, a switch 150 may be used as a so-called “kill switch” and may be provided on the tool 152. When the switch 150 is actuated (e.g. the state of the switch is changed), a magnet 154 is moved relative to a magnetically responsive sensor 156, and sensing such movement of the magnet, the sensor 156 provides a signal to the controller 158 to cause the engine operation to terminate. Such a kill switch 150 may be coupled to or otherwise communicated with the controller 158 to provide a signal to the controller when the switch is actuated, and the controller may then terminate engine operation, for example, by terminating some or all ignition events. In the example shown, the switch 150 may be carried by a housing 159 or other structure, and the magnet 154 may be carried by a toggle or pivot arm 160 that rotates about a pivot 162 to swing the magnet in a path detectable by the sensor 156, when the switch 150 is actuated. The switch 150 could instead by push, pull or otherwise actuated, the particular movement of the magnet 154 being within a path enable detection by the sensor 156. The switch may be biased or normally in the first position shown in FIG. 8 such that when not actuated, the switch returns the first position. To effect engine operation termination, the switch may need to be held in the second position until the engine operation sufficiently stops, or only a momentary actuation (of any desired momentary/time duration) may be needed to cause the controller to stop engine operation even if the switch returns or is returned to the first position.

As shown in FIG. 9, a switch/sensor 163 may include a magnet 164 that may be coupled to a user and a sensor 166 that may determine the presence of the magnet to determine the presence of the user relative to the tool 168. For example, the magnet 164 may be carried by or on a user's hand and the sensor may be located in an area in which the user's hand (e.g carried on or by a glove 170 worn by the user during use of the tool 168) is expected to be during operation of the tool. If the magnet 164 is detected by the sensor 166, then engine operation may be permitted. If the magnet 164 is not detected by the sensor 166, then engine operation may be terminated (e.g. by communicating this information via a signal to a controller 171 which may terminate engine operation). Thus, when the magnet 164 is not detected, the sensor/switch 163 acts as a kill switch to terminate engine operation. Or, the sensor 156 may enable actuation of a throttle valve, for example by actuation of at throttle control mechanism such as a trigger 172, only when the magnet 164 is sensed in a desired location or proximity to the sensor 166. In this way, the engine throttle can only be actuated by the user when the magnet 164 is sensed in a desired area for throttle actuation. This may reduce unintended or accidental throttle actuation. In at least some implementations, an additional sensor may be provided to act as a kill switch when the magnet is brought near to that sensor.

As also shown in FIG. 9, the magnet 164 could instead be movable or releasably coupled to the tool and a tether or other coupling member 174 may be coupled to the magnet and to the user. In this arrangement, upon movement of the user relative to the magnet 164, the tether 174 may move the magnet, which movement is detected by the sensor 166 and communicated with the controller 171. The tether 174 may be coupled to a user's hand, wrist, arm, torso, leg, or otherwise as desired to determine a proximity of the user to the tool 168.

As further shown in FIG. 9, the magnet 164 could instead be carried by a component, like a key or fob 180 that is positioned in a first position to enable starting and use of the tool 168 and moved to a second position to terminate engine operation and use of the tool. The key or fob 180 may be inserted into a slot or cavity 182 of the tool (e.g. in a handle or housing) in the first position and pulled or removed at least partially from the slot or cavity 182 in the second position. The key or fob 180 could be manually moved and/or it may be coupled to a tether that may also be coupled to the user.

In at least some implementations, the sensor may be mounted to the same circuit board as the controller with which the sensor is coupled for communication (either by wired or wireless communication). The controller (e.g. 158 or 171) may include an ignition circuit that controls the generation of a spark from a spark plug, and may also include one or more coils of wire in which energy is generated by the passing of magnets by the coils (e.g. magnets carried by a flywheel 183 (FIG. 8) in a capacitive discharge ignition system). In other implementations, a sensor may be mounted remotely from the circuit board and communicated with the controller either via a wire or wirelessly.

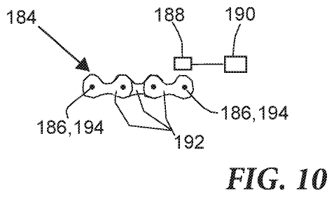

As shown in FIG. 10, a tool 184, such as a chainsaw chain, cutting blade, rotary component like an impeller, or the like, may include one or more magnets 186 (or magnetized components, which are also considered to be a magnet) that move when the tool is driven. One or more sensors 188 responsive to the magnetic field of the magnet(s) 186 may be located adjacent to a path of travel of the tool 184 and may send a signal to the controller 190 when a magnet 186 passes by the sensor 188. In this way, the speed of the tool 184 can be determined and the controller 190 can adjust certain operating conditions or factors as a function of the tool speed. For example, the controller 190 may adjust the ignition timing or actuate an electrically controlled valve to adjust a fuel and air mixture delivered to the engine or an electrically actuated controller (e.g. a motor) that adjusts the position of a valve, such as a throttle valve. With multiple magnets 186 carried by the tool 184, the controller 190 may be better able to determine changes in the engine speed, such as may be caused when the tool is under a load (e.g. cutting something or encountering some other resistance), to enable the controller 190 to better manage such changes in tool operating conditions. In the example of a chainsaw, one or more links 192 or pins 194 that interconnect the links 192 may include a magnet or be magnetized, and in the particular example shown in FIG. 10, some of the pins 194 define the magnets 186. All or less than all of the pins may be magnetized to provide any desired spacing of magnets and corresponding signals to the controller, as desired. While the magnets are shown as being magnetized pins of the saw chain, the magnets could be separate components mounted to the saw chain, if desired. In a multi-blade rotary cutting tool, one or more blades may include a magnet or be magnetized. Of course, other implementations may be used, as desired.

It is to be understood that the foregoing description is not a definition of the invention, but is a description of one or more preferred embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, a method having greater, fewer, or different steps than those shown could be used instead. All such embodiments, changes, and modifications are intended to come within the scope of the appended claims.

As used in this specification and claims, the terms “for example,” “for instance,” “e.g.,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A power tool, comprising:
an engine,
a tool driven for movement by the engine;
a brake mechanism coupled to the tool to inhibit movement of the tool in an engaged position of the brake mechanism and permit movement of the tool in a disengaged position of the brake mechanism;
a charge forming device coupled to the engine to provide a combustible fuel and air mixture to the engine, the charge forming device including a throttle valve movable between a first position and a second position; and
a transmission member operably coupled to the brake mechanism and the throttle valve so that the throttle valve is moved away from the first position when the brake mechanism is moved to the engaged position.

2. The power tool of claim 1 wherein the transmission member includes one or more of a rigid member and a cable.

3. The power tool of claim 1 wherein the brake mechanism includes a band having a fixed end and a movable end, and wherein the transmission member is operably coupled to the movable end of the band.

4. The power tool of claim 1 which also includes a clutch through which the engine drives the tool, and wherein the brake mechanism is coupled to the clutch in the engaged position.

5. The power tool of claim 1 wherein the charge forming device includes a throttle valve and a choke valve and wherein the transmission member is coupled to the choke valve to move the choke valve from an open position to a closed position when the brake mechanism is moved to the engaged position.

6. The power tool of claim 5 wherein the choke valve is operably coupled to the throttle valve so that upon movement of the choke valve to the closed position the throttle valve is moved to a position between the first position and second position.

7. The power tool of claim 1 wherein moving the brake mechanism to the disengaged position moves the throttle valve to the first position.

8. The power tool of claim 1 which also comprises a switch having a first state and a second state, and which is operable to provide an output indicative of the state of the switch to a controller, and wherein the switch is operably coupled to the brake mechanism so that the switch is in the first state when the brake mechanism is in the engaged position and the switch is in the second state when the brake mechanism is in the disengaged position.

9. The power tool of claim 8 wherein a component of the brake mechanism or a component moved by the brake mechanism engages the switch to change the state of the switch when the brake mechanism is moved to either the engaged or disengaged position.

10. The power tool of claim 8 wherein the switch is coupled to a microprocessor and to an electrical ground, where the electrical ground includes a portion of the brake mechanism or a portion of a clutch through which the engine drives the tool.

11. The power tool of claim 8 wherein the switch is defined by a magnet and a sensor responsive to relative movement between the magnet and sensor.

12. A power tool, comprising:
an engine,
a tool driven for movement by the engine;
a brake mechanism coupled to the tool to inhibit movement of the tool in an engaged position of the brake mechanism and permit movement of the tool in a disengaged position of the brake mechanism; and
a switch having a first state and a second state, and the switch is operably coupled to the brake mechanism so that the switch is in the first state when the brake mechanism is in the engaged position and the switch is in the second state when the brake mechanism is in the disengaged position.

13. The power tool of claim 12 wherein the brake mechanism includes a lever movable between a first position in which the brake mechanism is in the engaged position and a second position in which the brake mechanism is in the disengaged position, and wherein the state of the switch changes when the lever moves between the first and second positions.

14. The power tool of claim 12 which also includes a controller including a processing device, and wherein the switch is coupled to the controller so that the controller is responsive to a change of state of the switch.

15. The power tool of claim 12 wherein a component of the brake mechanism or a component moved by the brake mechanism engages the switch to change the state of the switch when the brake mechanism is moved to either the engaged or disengaged position

16. The power tool of claim 12 wherein the switch is defined by a magnet and a sensor responsive to relative movement between the magnet and sensor.

17. A method of controlling operation of a tool having an engine and a brake mechanism, comprising:
coupling the brake mechanism to one or both of a switch and a valve of a charge forming device so that: 1) actuating the brake mechanism changes the state of the switch and initiates an engine starting control routine and/or the position of the valve is changed; and 2) releasing the brake mechanism changes the position of the mechanical component to a desired position associated with operating the tool and/or changes the state of the switch to i) terminate the engine starting control routine, or ii) initiate a tool operating engine control routine.

18. The method of claim 17 which also includes configuring the tool so that the brake mechanism must be actuated in order to permit starting of the engine.

19. The method of claim 17 wherein the valve is a throttle valve and actuating the brake mechanism moves the throttle valve from an idle position to a position between the idle position and a wide open position.

20. The method of claim 19 wherein the brake mechanism is connected to a choke valve to move the choke valve when the brake mechanism is engaged, and wherein the movement of the choke valve causes movement of the throttle valve.

21. The method of claim 17 wherein the tool is configured to terminate engine operation upon actuation of the brake mechanism after the engine has been started by sending a signal to an engine controller when the state of the switch is changed by such actuation of the brake mechanism.

22. The method of claim 21 wherein the engine controller is configured to terminate at least some ignition events in the engine to cause the engine operation to terminate.

23.-29. (canceled)
